(19) United States
(12) Patent Application Publication
(10) Pub. No.: US 2004/0088576 A1
(43) Pub. Date: May 6, 2004

(54) Secure resource access

(76) Inventors: Ward Scott Foster, Boise, ID (US); Robert John Madril JR., Boise, ID (US); Shell Sterling Simpson, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/286,065

(22) Filed: Oct. 31, 2002

(51) Int. Cl. H04L 9/00

(52) U.S. Cl. 713/201

(57) ABSTRACT

Preventing replay attacks with no user involvement. A method according to one embodiment of the invention includes generating and providing a client with a ticket. When making a request to access the resource, the client digitally signs and includes the ticket. The request is received and the ticket and signature are verified before access to the resource is granted.

### FIELD OF THE INVENTION

The present invention is directed to accessing a distributed resource. More particularly, the invention is directed to securely accessing a resource while preventing replay attacks.

### BACKGROUND

In a basic desktop computing environment, a computer, accessing data from its hard drive, performs a specified function such as word processing, displaying information on a screen, and, when requested, producing a document on a connected printer. In a distributed computing environment, the resources found in the desktop environment are spread across any number of interconnected devices. For example, a client accesses a resource over the Internet. Accessing data provided by the client or located and retrieved from another device, the resource performs specified tasks. These tasks include, among a multitude of others, manipulating the data as instructed, returning the data for use by the client, and/or sending the data to a printer for production.

The following provides a more specific example of a distributed computing system utilized to print documents. A client computer, utilizing a web browser and the Internet, accesses a web server providing a document printing resource. The web server may be running on a device connected to or networked with one or more printers. Alternatively, the web server may be embedded in the printer itself. The printing resource locates available printers and a data resource managing electronic documents. The printing service then returns to the browser a graphical interface containing user accessible controls for selecting a document from the data resource as well as controls for selecting a printer. Selections made through the interface are returned to the printing resource. Accessing the data resource, the printing resource retrieves and/or sends the selected document to the selected printer for production.

Accessing distributed resources raises a number of security considerations. Access to a resource may be limited for commercial or privacy purposes. Using the example above, a user may be a paid subscriber enabling access to the printing resource. The user may pay a flat rate or may pay for each use. For commercial security, the user may be required to present credentials such as a user name and password in order to access the printing resource. The same may be true for the data resource. However, presenting credentials to the data resource also promotes user privacy. A user may store documents on the data resource that the user desires to keep private and secure.

Network communications can be intercepted. Where an intercepted communication is a request to access a resource that includes a user's credentials, that communication can be resubmitted to a resource at a later time without the user's knowledge or consent. This resubmission is commonly referred to as a replay attack. Because the resubmission includes verifiable credentials, access to the resource is granted. Existing methods for preventing replay attacks involve routinely changing a user's credentials. However, such changes inconvenience the user who is required to continually remember new passwords.

### SUMMARY

Accordingly, the present invention is directed to preventing replay attacks with no user involvement. A method according to one embodiment of the invention includes generating and providing a client with a ticket. When making a request to access the resource, the client digitally signs and includes the ticket. The request is received and the ticket and signature are verified before access to the resource is granted.

### DESCRIPTION OF THE DRAWINGS

FIG. 1 is a schematic representation of a computer network in which various embodiments of the present invention may be incorporated.

FIG. 2 is a block diagram of the network of FIG. 1 illustrating the logical program components operating on each device according to an embodiment of the present invention.

FIG. 3 is a block diagram illustrating the logical components of the verifier according to an embodiment of the present invention.

FIG. 4 is a flow diagram illustrating steps of a secure resource access method according to an embodiment of the present invention.

### DETAILED DESCRIPTION

Glossary:

Program: An organized list of electronic instructions that, when executed, causes a device to behave in a predetermined manner. A program can take many forms. For example, it may be software stored on a computer's disk drive. It may be firmware written onto read-only memory. It may be embodied in hardware as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components.

Client—Server: A model of interaction between two programs. For example, a program operating on one network device sends a request to a program operating on another network device and waits for a response. The requesting program is referred to as the “client” while the device on which the client operates is referred to as the “client device.” The responding program is referred to as the “server,” while the device on which the server operates is referred to as the “server device.” The server is responsible for acting on the client request and returning requested information, if any, back to the client. This requested information may be an electronic file such as a word processing document or spread sheet, a web page, or any other electronic data to be displayed or used by the client. In any given network there may be multiple clients and multiple servers. A single device may contain programming allowing it to operate both as a client device and as a server device. Moreover, a client and a server may both operate on the same device.

Web Server: A server that implements HTTP (Hypertext Transport Protocol). A web server can host a web site or a web service. A web site provides a user interface by supplying web pages to a requesting client, in this case a web browser. Web pages can be delivered in a number of formats including, but not limited to, HTML (Hyper-Text Markup Language) and XML (eXtensible Markup Language). Web pages may be generated on demand using server side scripting technologies including, but not limited to, ASP (Active Server Pages) and JSP (Java Server Pages). A web page is typically accessed through a network address. The network address can take the form of an URL (Uniform Resource Locator), IP (Internet Protocol) address, or any other unique addressing mechanism. A web service provides a programmatic interface which may be exposed using a variety of protocols layered on top of HTTP, such as SOAP (Simple Object Access Protocol).

Interface: The junction between a user and a computer program providing commands or menus through which a user communicates with the program. The term user represents generally any individual, mechanism, or other programming desiring to communicate with the program. For example, in the client-server model defined above, the server usually generates and delivers to a client an interface for communicating with a program operating on or controlled by the server device. Where the server is a web server, the interface is a web page. The web page when displayed by the client device presents a user with controls for selecting options, issuing commands, and entering text. The controls displayed can take many forms. They may include push-buttons, radio buttons, text boxes, scroll bars, or pull-down menus accessible using a keyboard and/or a pointing device such as a mouse connected to a client device. In a non-graphical environment, the controls may include command lines allowing the user to enter textual commands. Where the user is other programming, an interface is may be a programmatic interface enabling the user (programming) to interact with the computer program.

Digital Certificate: An attachment to an electronic message used for security purposes. The most common use of a digital certificate is to verify that a user sending a message is who he or she claims to be, and to provide the receiver with the means to encode a reply. An individual wishing to send an encrypted message applies for a digital certificate from a Certificate Authority (CA). The CA issues an encrypted digital certificate containing the applicant's public key and a variety of other identification information. The CA makes its own public key readily available through print publicity or perhaps on the Internet. The recipient of an encrypted message uses the CA's public key to decode the digital certificate attached to the message, verifies it as issued by the CA and then obtains the sender's public key and identification information held within the certificate. With this information, the recipient can send an encrypted reply.

Digital Signature: A digital code that can be attached to an electronically transmitted message that uniquely identifies the sender. Like a written signature, the purpose of a digital signature is to guarantee that the individual sending the message really is who he or she claims to be. Digital signatures are especially important for electronic commerce and are a key component of most authentication schemes. To be effective, digital signatures must be unforgeable. There are a number of different encryption techniques to guarantee this level of security. For example, a message can be signed with the sender's private key. The sender's public key can then be included with the message. The recipient can use the sender's public key to verify the signature.

INTRODUCTION: In distributed computing environments, a user employs a client to request access a network resource. The request includes the user's credentials which are required to be verified before access to the resource is granted. It is expected that various embodiments of the present invention will prevent a third party from intercepting and later successfully resubmitting the request in a replay attack.

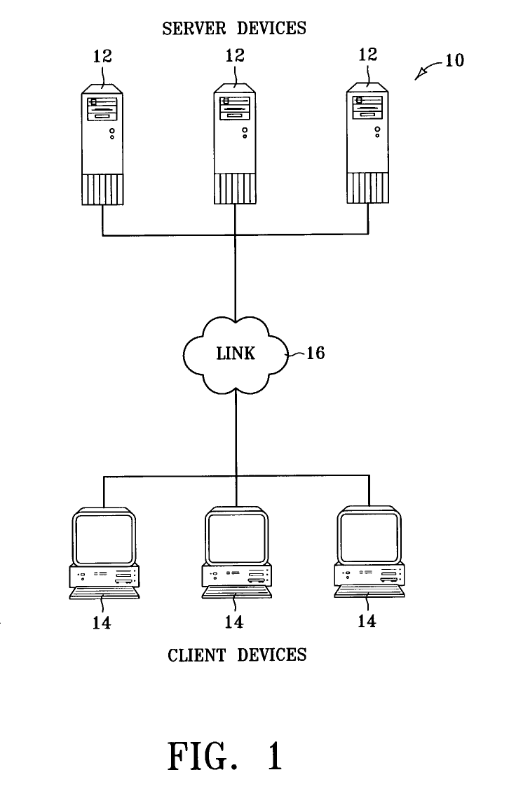

Although the various embodiments of the invention disclosed herein will be described with reference to the computer network 10 shown schematically in FIG. 1, the invention is not limited to use with network 10. The invention may be implemented in or used with any computer system in which it is necessary or desirable to access electronic data. The following description and the drawings illustrate only a few exemplary embodiments of the invention. Other embodiments, forms, and details may be made without departing from the spirit and scope of the invention, which is expressed in the claims that follow this description.

Referring to FIG. 1, computer network 10 represents generally any local or wide area network in which a variety of different electronic devices are linked. Network 10 includes server devices 12 and client devices 14 interconnected by link 16. Server devices 12 represent generally any computing devices capable of running programming for distributing resources over network 10. A resource, for example, may be a web page or a web service or any other programming or data capable of being distributed over network 10. Client devices 14 represent generally any computing devices running programming capable of interacting with server devices 12. While network 10 is illustrated as containing a set number of server devices 12 and a set number of client devices 14, network 10 may include any number of server devices 12 and client devices 14. Moreover, a given server device 12 may function as a client device 14 when interacting with another server device 12.

Link 16 interconnects devices 12 and 14 and represents generally a cable, wireless, or remote connection via a telecommunication link, an infrared link, a radio frequency link, or any other connector or system that provides electronic communication between devices 12 and 14. Link 16 may represent an intranet, an Internet, or a combination of both. Devices 12 and 14 can be connected to the network 10 at any point and the appropriate communication path established logically between the devices 12 and 14.

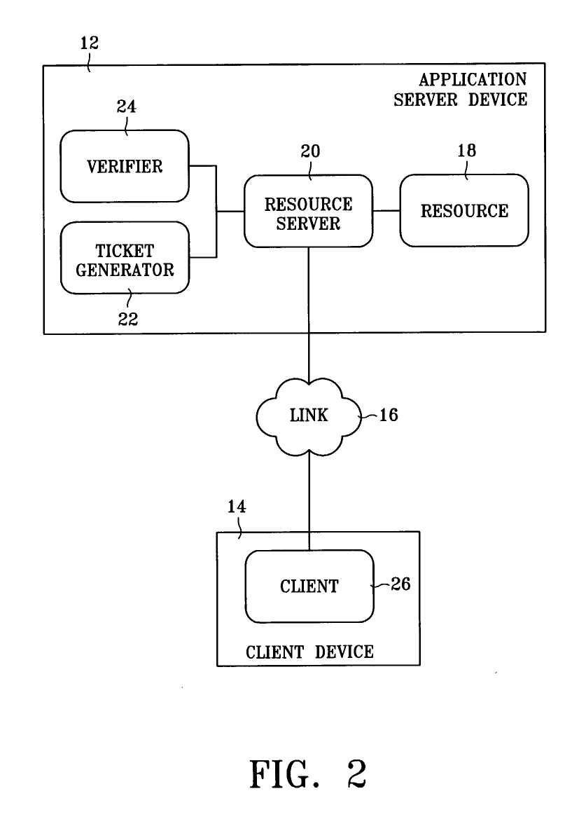

COMPONENTS: The logical components of one embodiment of the invented resource access system will now be described with reference to the block diagram of FIG. 2 which illustrates link 16 connecting a single server device 12 to a single client device 14. Server device 12 includes resource 18, resource server 20, ticket generator 22, and verifier 24. Resource 18 represents generally any electronic data or programming to be served or distributed to client device 14. Resource server 20 represents generally any programming capable of distributing resource 18. Resource server 20 is also capable of generating or otherwise providing a user interface (a resource interface) to be displayed by client device 14 enabling a user to interact with resource 18. Ticket generator 22 represents generally any programming capable of generating and providing an electronic ticket required to access resource 18. A ticket represents generally any electronic data to be associated with granting access of some kind to a resource 18. A ticket, for example, may be a text string associated with a, such as. Alternatively, a ticket may simply be random data preferably cryptographically generated.

Ticket generator 22 is also responsible for associating each ticket with data identifying a particular user and setting expiration criteria for each generated ticket. Expiration criteria may indicate that a ticket expires after a set number of uses and/or after a set time frame. For example, user data and expiration criteria for a given ticket may indicate the following: “Upon USER X signing the ticket, USER X is granted access to RESOURCE Y from CLIENT Z for a period of time not to begin before TIME A and that must end before TIME B.” Verifier 24 represents generally any programming capable of limiting access to resource 18 to those requests that include a properly signed and valid ticket. Where an expiration time or date is encoded into a ticket, verifier 24 will include a clock against which it can compare the time or date encoded into the ticket.

As a further security measure, ticket generator 22 may also be capable of adding a digital certificate or signature to a ticket. A digital certificate is a digital code that can be attached to an electronically transmitted data that uniquely identifies the sender. The certificate includes the public key and a variety of other identification information assigned to resource 18 by a CA (Certificate Authority). The CA makes its own public key readily available through print publicity or perhaps on the Internet. The recipient of a signed message uses the CA's public key to decode the digital certificate attached to the message and verifies it as issued by the CA confirming the sender's identity. Where a ticket includes a digital certificate, verifier 24 will include programming capable of verifying the authenticity of the certificate.

In this example, resource server 20 is a web server. Consequently, client device 14 includes client 26—programming in the form of a browser. The browser may be a commercially available web browser such as Microsoft's Internet Explorer. The browser may be an integral component of another program such as a word processor that enables the program to interact with resource server 20. Moreover, some of the functionality (discussed below) of the browser may be provided by extensions to the browser. Such an extension may be programming capable of issuing remote function calls using SOAP (Simple Object Access Protocol). SOAP requests can “piggyback” on top of common HTTP requests made by the browser. Because most firewalls do not block HTTP requests, firewalls do not block the piggybacked SOAP requests.

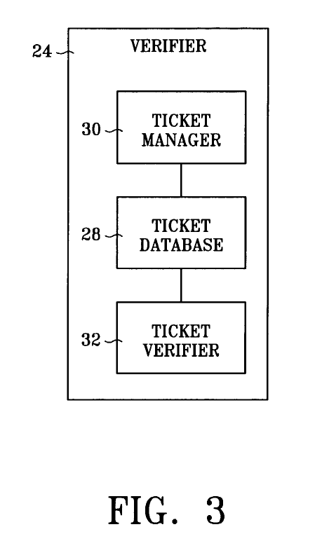

Referring now to FIG. 3, verifier 24 includes ticket database 28, ticket manager 30, and ticket verifier 32. Ticket database 28 represents logical memory containing tickets or copies of tickets generated by ticket generator 22 along with the user data and expiration criteria associated with each ticket. Ticket manager 30 represents any programming capable of adding a newly generated ticket along with its associated expiration criteria and user data to ticket database 28. Ticket manager 30 is also responsible for invalidating tickets according to each ticket's expiration criteria. Ticket verifier 32 represents any programming capable of authenticating a ticket presented with a request to access resource 18.

The block diagrams of FIGS. 2 and 3 show the architecture, functionality, and operation of one implementation of the present invention. If embodied in software, each block may represent a module, segment, or portion of code that comprises one or more executable instructions to implement the specified logical function(s). If embodied in hardware, each block may represent a circuit or a number of interconnected circuits to implement the specified logical function(s).

Also, the present invention can be embodied in any computer-readable medium for use by or in connection with an instruction execution system such as a computer/processor based system or other system that can fetch or obtain the logic from the computer-readable medium and execute the instructions contained therein. A “computer-readable medium” can be any medium that can contain, store, or maintain programs and data for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, a portable magnetic computer diskette such as floppy diskettes or hard drives, a random access memory (RAM), a read-only memory (ROM), an erasable programmable read-only memory, or a portable compact disc.

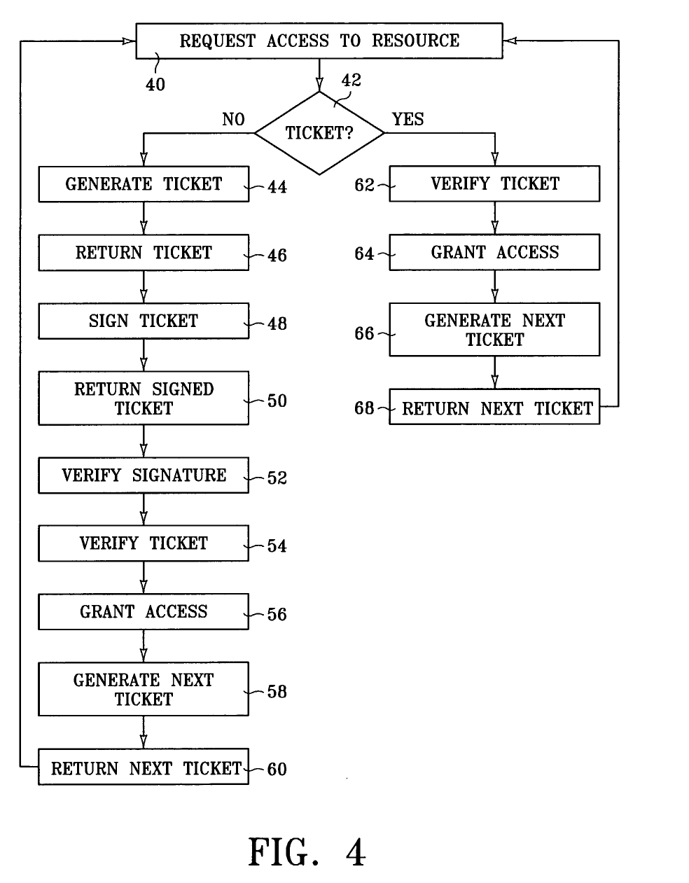

OPERATION: The operation of a resource access method according to one embodiment of the invention will now be described with reference to the flow diagram of FIG. 4. FIG. 4 illustrates an example of steps taken to grant a user's request to access resource 18. In this example, resource server 20 is a web server. Requests to access resource 18 are HTTP (Hyper Text Transport Protocol) requests issued by client 26.

Client 26 requests access to resource 18 (step 40). Requesting access to resource 18 typically involves making a remote procedure call to resource server 20. The request includes data identifying a user. This remote procedure call will normally be made using SOAP (Simple Object Access Protocol), which “piggybacks” on top of HTTP (Hyper Text Transport Protocol)—the same protocol typically used by web browsers. Piggybacking a SOAP request on HTTP allows the request to travel through firewalls. Most enterprises allow HTTP requests to be made by clients inside the enterprise firewall to servers that reside outside the firewall. Resource server 20 receives the request and determines whether the request includes a ticket (step 42). Where, as in this case, the request is an initial request to access resource 18, the request will not include a ticket. Consequently, resource server 20 directs ticket generator 22 to generate a ticket and associate that ticket with the data identifying the user and with expiration criteria (step 44). Ticket manager 30 saves a copy of the ticket and associated user data and expiration criteria in ticket database 28. Resource server 20 then returns the ticket to client 26 (step 46).

Client 26 receives and digitally signs the ticket for the user. For example, the ticket may be a cryptographically generated string such as “blurbmok.” To sign the ticket, client 26 uses the user's private key to encrypt the string—and adds the encrypted data to the ticket along with the user's public key. The result ting signed ticket looks like this “blurbmok+signature” where signature=“encrypted (blurbmok)+public key.” Client 26 returns the signed ticket once again requesting access to resource 28 (step 50). Resource server 20 receives the request and directs verifier 24 to verify the ticket's signature and the ticket (steps 52 and 54). To verify the signature, ticket verifier 32 uses the provided public key to decrypt the signature and then compares the result with the ticket string. If the two match the signature is verified. If not, verifier 24 denies the request. To verify the ticket, ticket verifier 32 locates, within ticket database 28, the user data and expiration criteria associated with the ticket. Ticket verifier than determines whether the ticket is valid. Where the ticket has expired or is otherwise invalid, ticket verifier 24 denies the request.

Where the signature and ticket are properly verified, ticket verifier 24 grants client 26 access to resource 18 (step 56). Ticket generator 22 generates a next ticket with expiration credentials (step 58). A next ticket is a ticket to be used by client 26 when making a subsequent request to access resource 18. Ticket manager 30 saves the next ticket in ticket database 28 along with its expiration credentials. Resource server 20 then returns the next ticket to client 26.

When making a subsequent request of resource 18, client 26 signs and submits the next ticket and the process repeats with step 40. Except in this case, the request includes a ticket—the next ticket generated in step 58. Resource server 20 receives the request, determines that the request includes a ticket, and instructs verifier 24 to verify the ticket and its signature (step 62). Where the ticket is properly verified, verifier 24 grants client 26 access to resource 18 (step 64). Ticket generator 22 generates a next ticket association the ticket with user data and expiration credentials (step 66). Ticket manager 30 saves the next ticket and associated data in ticket database 28. Resource server 20 then returns the next ticket to client 26 (step 68).

While the process illustrated in FIG. 4 is occurring, ticket manager 30 may continually or at least periodically monitor ticket database 28 and invalidate tickets according to each ticket's expiration criteria. Where a ticket is set to expire after a single use, a third party who has intercepted a request to access resource 18 cannot successfully replay that request. In such a case, ticket manager 30 will have invalidated the ticket accompanying the request and verifier 24 will deny access.

Although the flow chart of FIG. 4 shows a specific order of execution, the order of execution may differ from that which is depicted. For example, the order of execution of two or more blocks may be scrambled relative to the order shown. Also, two or more blocks shown in succession may be executed concurrently or with partial concurrence. All such variations are within the scope of the present invention.

The present invention has been shown and described with reference to the foregoing exemplary embodiments. It is to be understood, however, that other forms, details, and embodiments may be made without departing from the spirit and scope of the invention which is defined in the following claims.

What is claimed is:

1. In a computer network, a method comprising:
generating and providing a client with a ticket;
receiving, from the client, an access request for a resource, the request including the ticket, the ticket being digitally signed; and
verifying the ticket received with the access request and its signature before granting the client access to the resource.

2. The method of claim 1, wherein generating comprises generating and providing a client with a first ticket, the method further comprising generating and providing the client with a second ticket to be supplied by the client with a subsequent request to access the resource.

3. The method of claim 1, further comprising retaining a copy of the ticket with, and wherein verifying comprises comparing the ticket received with the access request with the retained copy.

4. The method of claim 1, further comprising invalidating the ticket after receiving the access request from the client.

5. The method of claim 1, wherein the act of generating the ticket comprises generating the ticket with expiration criteria, the method further comprising invalidating the ticket according to the expiration criteria.

6. The method of claim 1, wherein generating the ticket comprises generating the ticket with expiration criteria in the form of an expiration time, and wherein verifying includes determining whether the expiration time has passed.

7. In a computer network, an authentication method, comprising:
receiving, from a client, an access request for a resource;
generating and providing the client with a ticket;
the client digitally signing and returning the signed ticket; and
granting access to the resource after verifying the ticket and its signature.

8. The method of claim 7, further comprising, after granting access, invalidating the ticket and generating and providing the client with a second ticket to be supplied by the client with a subsequent request to access the resource.

9. The method of claim 7, wherein the act of generating comprises generating the ticket with expiration criteria, the method further comprising invalidating the ticket according to the expiration criteria.

10. The method of claim 7, further comprising:
invalidating the ticket after granting access;
generating and providing the client with a second ticket;
receiving, from the client, a second request to access the resource along with the second ticket, the second ticket being digitally signed; and
granting the second request to access the resource after verifying the second ticket and its signature.

11. The method of claim 10, further comprising invalidating the second ticket after granting the second request and generating and providing the client with a third ticket to be supplied with a subsequent request to access the resource.

12. The method of claim 10, further comprising:
invalidating the second ticket after granting the second request to access the resource;
generating and providing the client with a third ticket;
receiving, from the client, a third request to access the resource along with the third ticket, the third ticket being digitally signed; and
granting the third request to access the resource after verifying the third ticket and its signature.

13. In a computer network, an authentication method, comprising:
receiving, from a client, an access request for a resource;
generating and providing the client with a first ticket;
receiving from the client the first ticket, the first ticket being digitally signed;
granting access to the resource after verifying the first ticket and its signature;
invalidating the first ticket;
generating and providing the client with a second ticket;
receiving, from the client, a second request to access the resource along with the second ticket, the second ticket being digitally signed; and
granting the second request to access the resource after verifying the second ticket and its signature.

14. In a computer network, an authentication method, comprising:
receiving from a client a request to access a resource;
determining whether the request includes a ticket;
if the request does not include a ticket:
generating and providing the client with a new ticket;
receiving from the client the ticket, the new ticket being digitally signed; and
granting access to the resource after verifying the new ticket and its signature; and
if the request includes a digitally signed existing ticket, granting access to the resource after verifying the existing ticket and its signature.

15. Computer readable media having instructions for:
generating and providing a client with a ticket;
receiving, from the client, an access request for a resource, the request including the ticket, the ticket being digitally signed; and
verifying the ticket received with the access request and its signature before granting the client access to the resource.

16. The media of claim 15, wherein the instructions for generating comprise instructions for generating and providing a client with a first ticket, the media having further instructions for generating and providing the client with a second ticket to be supplied by the client with a subsequent request to access the resource.

17. The media of claim 15, having further instructions for retaining a copy of the ticket, and wherein the instructions for verifying comprise instructions for comparing the ticket received with the access request with the retained copy.

18. The media of claim 17, having further instructions for invalidating the ticket after receiving the access request from the client.

19. The media of claim 17, wherein the instructions for generating the ticket comprise instructions for generating the ticket with expiration criteria, the media having further instructions for invalidating the ticket according to the expiration criteria.

20. The media of claim 17, wherein the instructions for generating the ticket comprise instructions for generating the ticket with expiration criteria in the form of an expiration time, and wherein the instructions for verifying include instructions for determining whether the expiration time has passed.

21. Computer readable media having instructions for:
receiving, from a client, an access request for a resource;
generating and providing the client with a ticket;
receiving the ticket from the client, the ticket being digitally signed; and
granting access to the resource after verifying the ticket and its signature.

22. The media of claim 21, having further instructions for, after granting access, invalidating the ticket and generating and providing the client with a second ticket to be supplied by the client with a subsequent request to access the resource.

23. The media of claim 21, wherein the instructions for generating comprise instructions for generating the ticket with expiration criteria, the media having further instructions for invalidating the first ticket according to the expiration criteria.

24. The media of claim 21, having further instructions for:
invalidating the ticket after granting access;
generating and providing the client with a second ticket;
receiving, from the client, a second request to access the resource along with the second ticket, the second ticket being digitally signed; and
granting the second request to access the resource after verifying the second ticket and its signature.

25. The media of claim 24, having further instructions for invalidating the second ticket after granting the second request and generating and providing the client with a third ticket to be supplied with a subsequent request to access the resource.

26. The media of claim 24, having further instructions for:
invalidating the second ticket after granting the second request to access the resource;
generating and providing the client with a third ticket;
receiving, from the client, a third request to access the resource along with the third ticket, the third ticket being digitally signed; and
granting the third request to access the resource after verifying the third ticket and its signature.

27. Computer readable media having instructions for:
receiving, from a client, an access request for a resource;
generating and providing the client with a first ticket;
receiving the first ticket from the client, the first ticket being digitally signed;
granting access to the resource after verifying the first ticket and its signature;
invalidating the first ticket;
generating and providing the client with a second ticket;
receiving, from the client, a second request to access the resource along with the second ticket, the second ticket being digitally signed; and
granting the second request to access the resource after verifying the second ticket and its signature.

28. Computer readable media having instructions for:
receiving from a client a request to access a resource;
determining whether the request includes a ticket;
if the request does not include a ticket:
generating and providing the client with a new ticket;
receiving from the client the ticket, the new ticket being digitally signed; and
granting access to the resource after verifying the new ticket and its signature; and
if the request includes a digitally signed existing ticket, granting access to the resource after verifying the existing ticket and its signature.

29. In a computer network, an authentication system for granting a request from a client to access a resource, comprising:
a ticket generator operable to generate tickets to be supplied by the client when making requests to access the resource;
a resource server operable to receive access requests and tickets from the client and to provide the client with tickets generated by the ticket generator; and
a verifier operable to verify a ticket received by the resource server from the client and to grant access to the resource upon verification of that ticketand data used to sign the ticket.

30. The system of claim 29, wherein the verifier includes:
a ticket manager operable to store copies of tickets generated by the ticket generator in a ticket database; and
a ticket verifier operable to verify a signature used to sign a ticket received from the client, to search for a valid ticket in the ticket database that matches the ticket received from the client, and to grant access to the resource upon finding a match.

31. The system of claim 30, wherein the ticket manager is further operable to invalidate a matching ticket found in the ticket database after granting access to the resource.

32. The system of claim 30, wherein the ticket generator is further operable to generate tickets with expiration criteria, and the ticket manager is further operable to store copies of each ticket and expiration criteria for that ticket generated by the ticket generator in the ticket database and to invalidate copies of tickets in the ticket database according to each ticket's expiration criteria.

33. The system of claim 29, wherein the ticket generator is further operable to generate tickets with expiration criteria, and the verifier is further operable to invalidate tickets according to each ticket's expiration criteria.

34. In a computer network, an authentication system for granting a request from a client to access a resource, comprising:
a ticket generator operable to generate tickets to be supplied by the client when making requests to access the resource;
a resource server operable to receive access requests and digitally signed tickets from the client and to provide the client with tickets generated by the ticket generator; and
a verifier operable to verify a digitally signed ticket received by the resource server from the client and to grant access to the resource upon verification of that ticket and its signature.

35. The system of claim 34, wherein the verifier includes:
a ticket manager operable to store copies of tickets generated by the ticket generator in a ticket database; and
a ticket verifier operable to verify a signature used to sign a ticket received from the client, to search for a valid ticket in the ticket database that matches the ticket received from the client, and to grant access to the resource upon finding a match.

36. The system of claim 35, wherein the ticket manager is further operable to invalidate a matching ticket found in the ticket database after granting access to the resource.

37. The system of claim 35, wherein the ticket generator is further operable to generate tickets with expiration criteria, and the ticket manager is further operable to store copies of each ticket and expiration criteria for that ticket generated by the ticket generator in the a ticket database and to invalidate copies of tickets in the ticket database according to each ticket's expiration criteria.

38. The system of claim 34, wherein the ticket generator is further operable to generate tickets with expiration criteria, and the verifier is further operable to invalidate tickets according to each ticket's expiration criteria.

39. In a computer network, an authentication system for granting a request from a client to access a resource, comprising:
a means for generating and tickets to be supplied by the client when making requests to access the resource;
a means for providing the client with tickets
a means for receiving access requests and digitally signed tickets from the client;
a means for verifying a digitally signed ticket received from the client; and
a means for granting access to the resource upon verification of that ticket.
